(19) United States
(12) Patent Application Publication
(10) Pub. No.: US 2025/0077899 A1
(43) Pub. Date: Mar. 6, 2025

(54) SYSTEMS AND METHODS FOR KNOWLEDGE GRAPHS

(71) Applicant: Palantir Technologies Inc., Denver, CO (US)

(72) Inventors: Cenk Sezgin, Brooklyn, NY (US); Mihir Pandya, San Jose, CA (US); Gregorian Pirindev, London (GB); Weihe Tian, New York, NY (US)

(21) Appl. No.: 18/812,389

(22) Filed: Aug. 22, 2024

Related U.S. Application Data
(60) Provisional application No. 63/536,226, filed on Sep. 1, 2023.

(51) Int. Cl. G06N 5/02; G06N 3/0475

(52) U.S. Cl. CPC G06N 5/02; G06N 3/0475

(57) ABSTRACT

Systems and methods for data hydration are provided. In some examples, a method includes accessing a compiler. In some examples, the compiler is associated with a source graph, a domain graph, and a mapping profile. In some examples, the domain graph includes one or more domain data schemas. In some examples, the method further includes receiving a source dataset from a source system, and applying the compiler to the source dataset from the source system to generate a domain dataset. In some examples, the domain dataset uses at least one of the one or more domain data schemas. In some examples, the method is performed using one or more processors.

### CROSS REFERENCE TO RELATED APPLICATIONS

This application claims priority to U.S. Provisional Application No. 63/536,226, entitled “SYSTEMS AND METHODS FOR KNOWLEDGE GRAPHS,” and filed on Sep. 1, 2023, which is incorporated by reference herein for all purposes in its entirety.

### TECHNICAL FIELD

Certain embodiments of the present disclosure relate to knowledge graphs. More particularly, some embodiments of the present disclosure relate to building, managing, and using knowledge graphs.

### BACKGROUND

A knowledge graph may be used to represent a network of entities. In some examples, entities represented in a knowledge graph may include objects, events, situations, concepts, or the like. Further, in some examples, knowledge graphs may be used to illustrate relationships among the entities.

Hence, it is desirable to improve techniques for building, managing, and using knowledge graphs.

### SUMMARY

Certain embodiments of the present disclosure relate to knowledge graphs. More particularly, some embodiments of the present disclosure relate to building, managing, and using knowledge graphs.

At least some aspects of the present disclosure are directed to a method for data hydration. In some examples, the method includes accessing a compiler. In some examples, the compiler is associated with a source graph, a domain graph, and a mapping profile. In some examples, the domain graph includes one or more domain data schemas. In some examples, the method further includes receiving a source dataset from a source system, and applying the compiler to the source dataset from the source system to generate a domain dataset. In some examples, the domain dataset uses at least one of the one or more domain data schemas. In some examples, the method is performed using one or more processors.

At least some aspects of the present disclosure are directed to a system for data hydration. In some examples, the system includes at least one processor and at least one memory that, when executed by the at least one processor, causes the system to perform a set of operations. In some examples, the set of operations include accessing a compiler. In some examples, the compiler is associated with a source graph, a domain graph, and a mapping profile. In some examples, the domain graph includes one or more domain data schemas. In some examples, the set of operations further includes receiving a source dataset from a source system, and applying the compiler to the source dataset from the source system to generate a domain dataset. In some examples, the domain dataset uses at least one of the one or more domain data schemas.

At least some aspects of the present disclosure are directed to a method for data hydration. In some examples, the method includes generating a compiler using a knowledge graph. In some examples, the knowledge graph includes a source graph, a domain graph, and a mapping profile. In some examples, the method further includes receiving a source dataset from a source system, and applying the compiler to the source dataset from the source system to generate a domain dataset by: converting the source dataset to the source data corresponding to the source graph and converting the source data corresponding to the source graph to the domain dataset corresponding to the domain graph. In some examples, the source dataset is vendor-specific and the source graph is vendor agnostic. In some examples, the domain dataset is domain-specific. In some examples, the method if performed using one or more processors.

Depending upon embodiment, one or more benefits may be achieved. These benefits and various additional objects, features and advantages of the present disclosure can be fully appreciated with reference to the detailed description and accompanying drawings that follow.

### BRIEF DESCRIPTION OF THE DRAWINGS

FIG. 1 is an illustrative diagram for a data hydration and query environment, according to certain embodiments of the present disclosure.

FIG. 2 is a simplified diagram showing a data hydration system and workflow, according to certain embodiments of the present disclosure.

FIG. 3 is a simplified diagram showing a data hydration system and workflow, according to certain embodiments of the present disclosure

FIG. 4 is a simplified diagram showing a method for data hydration, according to certain embodiments of the present disclosure.

FIG. 5 is an example architecture of a data hydration system, according to certain embodiments of the present disclosure.

FIG. 6 illustrates a simplified diagram showing a computing system, according to certain embodiments of the present disclosure.

### DETAILED DESCRIPTION

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g., 1 to 5 includes 1, 1.5, 2, 2.75, 3, 3.80, 4, and 5) and any range within that range.

Although illustrative methods may be represented by one or more drawings (e.g., flow diagrams, communication flows, etc.), the drawings should not be interpreted as implying any requirement of, or particular order among or between, various steps disclosed herein.

However, some embodiments may require certain steps and/or certain orders between certain steps, as may be explicitly described herein and/or as may be understood from the nature of the steps themselves (e.g., the performance of some steps may depend on the outcome of a previous step). Additionally, a “set,” “subset,” or “group” of items (e.g., inputs, algorithms, data values, etc.) may include one or more items and, similarly, a subset or subgroup of items may include one or more items. A “plurality” means more than one.

As used herein, the term “based on” is not meant to be restrictive, but rather indicates that a determination, identification, prediction, calculation, and/or the like, is performed by using, at least, the term following “based on” as an input. For example, predicting an outcome based on a particular piece of information may additionally, or alternatively, base the same determination on another piece of information. As used herein, the term “receive” or “receiving” means obtaining from a data repository (e.g., database), from another system or service, from another software, or from another software component in a same software. In certain embodiments, the term “access” or “accessing” means retrieving data or information, and/or generating data or information.

Conventional systems and methods often include vendor-specific source systems (e.g., source data systems) used for storing data and then apply logic or data transformations in an application layer to the data. Conventional systems and methods typically include specific data transformation logic to covert data from vendor-specific source systems to a domain (e.g., an application, an industry, etc.) for data integrations. As such, conventional systems and methods are labor-intensive and cost-intensive. Further, conventional systems and methods are often source-specific, application-specific, and/or domain-specific.

Various embodiments of the present disclosure can achieve benefits and/or improvements by a computing system, for example, using knowledge graphs and/or a compiler to improve the data hydration (e.g., data transformation) process. In some embodiments, benefits include significant improvements, including, for example, data transformation and/or data hydration of data from multiple source systems into domain data used for different domains (e.g., industries, applications, uses, etc.). In certain embodiments, other benefits include improving efficiencies for data transformations and/or data hydrations. In some embodiments, benefits further include the capability of converting data from multiple source systems using a single compiler and one or more knowledge graphs. In certain embodiments, systems and methods are configured to use knowledge graphs (e.g., encoded into a language) and the compiler (e.g., the compiler for the language) to populate data, convert data, and/or use data.

According to certain embodiments, systems and methods are directed to the build, manage, and use of knowledge graphs including source graphs and/or domain graphs. In some embodiments, a knowledge graph represents a network of entities (e.g., objects, events, situations, or concepts, etc.) and illustrates the relationship among the entities. In certain embodiments, a source graph represents a network of entities in a source system. In some embodiments, a domain graph represents a network of entities in a domain (e.g., an industry, an application, etc.). In certain embodiments, an entity may be a semantic object such as a user, a person, a team, a task, an initiative, a customer, a geographic location, a building, a project, a workflow, a product, an event, a concept, and/or other types of objects.

In some embodiments, the systems and methods help and/or enable unintentional compounding of the knowledge (e.g., institutional knowledge) created on the field via a compiler. In certain embodiments, the systems and methods enable the software opinionated with the field knowledge while interacting with one or more computing models, for example, machine learning models, deep learning models, language models, generative artificial intelligence (AI) models, large language models (LLMs), and/or the like. In some embodiments, a model, also referred to as a computing model, includes a model to process data and/or to generate data. In certain embodiments, a model includes, for example, an artificial intelligence (AI) model, a machine learning (ML) model, a deep learning (DL) model, a language model, a generative AI model, a large language model (LLM), an image processing model, an algorithm, a rule, other computing models, and/or a combination thereof.

In certain embodiments, a generative AI model is a type of AI model that can be used to produce various type of content, such as text, images, videos, audio, 3D (three-dimensional) data, 3D models, a combination thereof, and/or the like. In some embodiments, a language model or a large language model (LLM), which is a type of generative AI models, includes content and training data embedded in the model. In certain embodiments, a language model or an LLM is configured to generate textual content.

According to certain embodiments, a language model may include a computing model that can generate probabilities of a sequence of words in natural language (NL). In some embodiments, language models include, for example, word representation models, unigram language models, n-gram models, exponential language models, neural network language models, NL processing models, machine-learning NL processing models, recurrent neural network neural models, and/or the like. In certain embodiments, the language models can be used for a number of different tasks including sentiment analysis, entity recognition, topic model, speech recognition, and many more. In some embodiments, a language model may generate many combinations of one or more next words (and/or sentences) that are coherent and contextually relevant. In certain embodiments, a language model can include one or more models for understanding, generating, and processing natural languages.

According to some embodiments, a large language model (“LLM”) includes any type of language model that has been trained on a large data set and/or has a large number of training parameters. In certain embodiments, the LLM includes a deep-learning model. In some embodiments, the LLM can understand and generate natural language texts. In certain embodiments, the LLM is trained using self-supervised learning and/or semi-supervised learning. For example, an LLM may be an autoregressive language model, such as a Generative Pre-trained Transformer 3 (GPT-3) model, Generative Pre-trained Transformer 4(GPT-4) model, and/or the like.

According to some embodiments, the systems and methods use a compiler (e.g., a computing-engine agnostic compiler) to hydrate parts of the knowledge graph via different computation systems. In certain embodiments, hydrating or hydration refers to transforming data, populating data to a data schema (e.g., an object, a graph of objects, a data node, a database, etc.) or other data structures, and/or storing the data. In some embodiments, some users on the field have been struggling with a technical problem to compound their knowledge on the field in a source system agnostic way and in a domain-driven way. In certain embodiments, the systems and methods solve the technical problem with the source graphs (e.g., ERPs (enterprise resource planning), CRMs (customer relationship management), etc.) and domain graphs. In some embodiments, the systems and methods hydrate one or more nodes in the knowledge graph via the compiler that can hydrate these nodes as datasets and ontology object types. In certain embodiments, an ontology refers to a structural framework (e.g., data model) containing information and data related to objects and relationships of objects (e.g., functions applicable to objects, links) within a specific domain (e.g., an organization, an industry). In some embodiments, a domain refers to an industry, an organization, a use case (e.g., a use scenario, an application), and/or the like.

According to certain embodiments, the systems and methods provide an opinionated knowledge graph (e.g., industry-specific, application-specific, domain-specific, etc.) to facilitate generating and/or generate one or more prompts (e.g., queries) before sending to one or more AI models (e.g., LLMs). In some embodiments, the systems and methods can hydrate ontologies (e.g., populate data to a data structure) using the compiler. In certain embodiments, the systems and methods can contribute (e.g., enter, input, etc.) knowledge (e.g., field knowledge, industry knowledge, etc.) to the knowledge graph. In some embodiments, the systems and methods can communicate with an AI model to navigate the knowledge graph. In certain embodiments, the systems and methods can communicate with a generative AI model to navigate the knowledge graph. In some examples, the systems and methods can communicate with an LLM to navigate the knowledge graph.

According to some embodiments, the systems and methods in the present disclosure can solve the problems of providing a scaled solution for knowledge and resources, for example, by receiving, generating, managing, and/or updating knowledge graph components (e.g., primitives, source graphs, domain graphs, mapping profiles, etc.). In certain embodiments, the conventional data stores (e.g., pods, data repositories, etc.) are struggling to store knowledge on existing infrastructure due to the rigidity of the existing infrastructure. For example, the conventional system does not provide a mechanism for knowledge (e.g., expertise, experience, etc.) to compound on software. In certain embodiments, the systems and methods use an LLM. In some embodiments, the systems and methods include software-defined ways to productize and capitalize on knowledge gathered at the field using the granular and/or modular approaches.

In some embodiments, conventional systems have a dependency on the vendor data models and/or interfaces (e.g., software interfaces, application programming interfaces). In certain embodiments, conventional systems incur high cost of data integration at each layer of the software stack. In some embodiments, conventional systems only provide read-only unidirectional data movement (e.g., from source to a data lake). In certain embodiments, conventional systems do not have cross-vendor standards on data interfaces (e.g., data ingestion, semantic, write-back, etc.). In some embodiments, conventional systems include business logic scattered within the system and/or tight dependency on getting data before developing a software application using the data.

According to certain embodiments, the systems and methods of the present disclosure build and use a knowledge graph, where the knowledge graph includes one or more components (e.g., primitives) of one or more domain graphs, one or more source graphs, and one or more mapping profiles, for example, to facilitate data hydrations and/or data integrations. In some embodiments, the systems and methods use a distributed compiler connecting components (e.g., primitives) to services of the software solution and/or platform (e.g., pipeline builder, workflow, etc.). In certain embodiments, the systems and methods include an engine connecting graphs in LLMs with the knowledge graph to augment and add context to existing platform applications (e.g., pipeline builder, workflow, etc.).

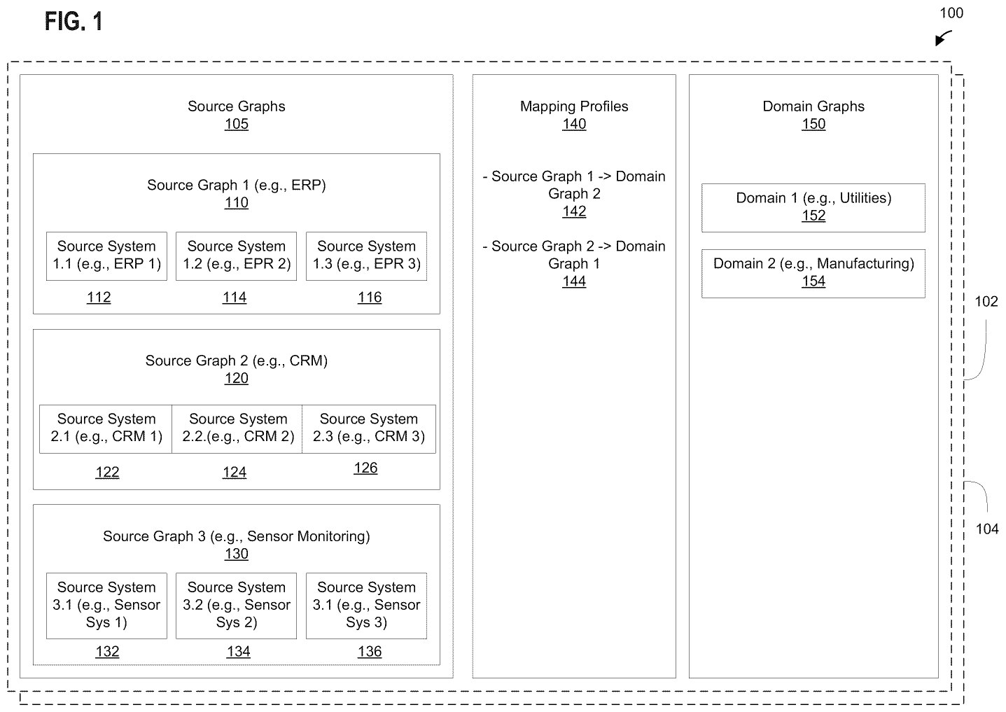

FIG. 1 is an illustrative diagram for data hydration (e.g., data conversion, data transformation, etc.) and query environment 100, according to certain embodiments of the present application. FIG. 1 is merely an example. One of ordinary skill in the art would recognize many variations, alternatives, and modifications. For example, some of the components may be expanded, integrated, and/or combined. Other components may be inserted into those noted above. Depending upon the embodiment, the arrangement of components may be interchanged with others replaced. Further details of these components are found throughout the present disclosure.

According to certain embodiments, the data hydration and query environment 100 includes one or more data hydration and query systems 102. In some embodiments, the data hydration and query system 102 includes one or more source graphs 105, one or more mapping profiles 140, and one or more domain graphs 150. In certain embodiments, the data hydration and query system 102 uses a language representing a knowledge graph 104, which includes the one or more source graphs 105, the one or more mapping profiles 140, and the one or more domain graphs 150. In some embodiments, the data hydration and query system 102 includes a compiler configured to perform data hydration using the knowledge graph 104.

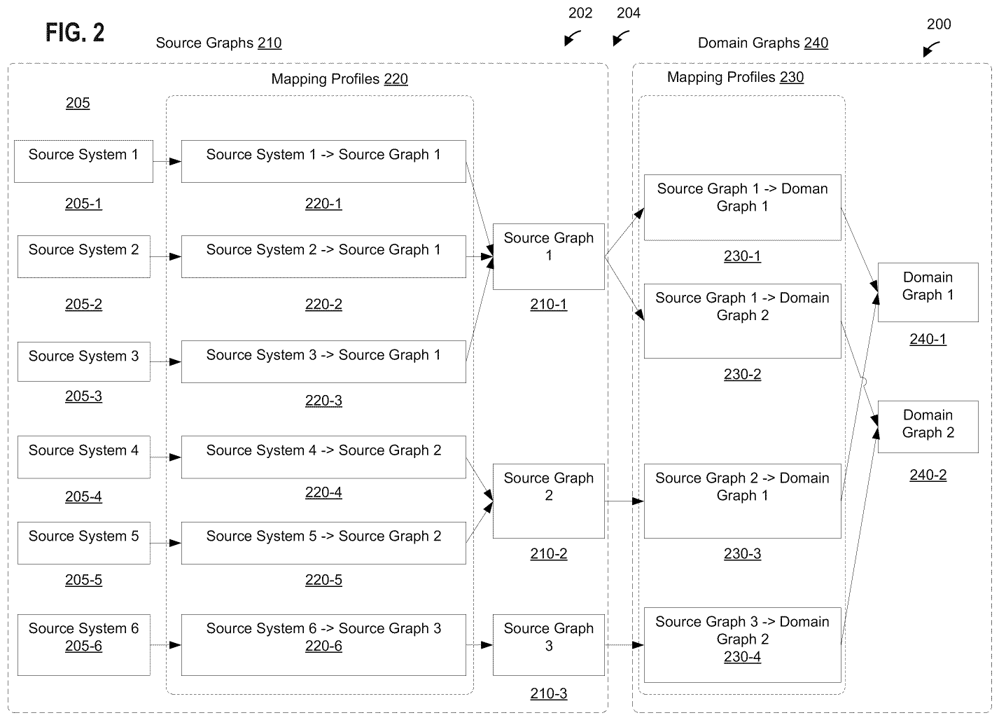

According to some embodiments, the knowledge graph 104 includes one or more source graphs 105 (e.g., source graph 110, source graph 120, source graph 130, etc.). In certain embodiments, a source graph 105 is an abstraction of a type of source system (e.g., ERP systems, CRM systems, sensor monitoring systems, etc.). In some embodiments, a source graph 110 is an abstraction of a type of source system including source system 112, source system 114, and source system 116, for example. In certain embodiments, a source graph 120 is an abstraction of a type of source system including source system 122, source system 124, and source system 126, for example. In some embodiments, a source graph 130 is an abstraction of a type of source system including source system 132, source system 134, and source system 136, for example. In certain embodiments, the abstraction is completed using a mapping profile (e.g., the mapping profile 220 in FIG. 2). In some embodiments, each source system has a source data schema. In certain embodiments, a source system has a vendor-specific data schema. For example, the source system 112 has a first source data schema for a first vendor, and the source system 114 has a second source data schema for a second vendor different from the first vendor, where the first source data schema is different from the second source data schema. In some embodiments, a source graph, including one or more source graph elements, is a graph database that uses nodes to store data entities and edges to store relationships between entities.

According to some embodiments, the knowledge graph 104 includes one or more mapping profiles 140. In certain embodiments, a mapping profile 140 includes one or more mapping logic libraries (e.g., mapping logic library 142, mapping logic library 144, etc.). In some embodiments, a mapping profile 140 includes a set of mapping rules (e.g., mapping rules 142, mapping rules 144, etc.). In certain embodiments, a mapping profile 140 includes a modular mapping library. In some embodiments, a mapping profile 140 supports certain capabilities (e.g., platform capabilities, authoring, pipeline builder, for a domain, for a use case, etc.). In certain embodiments, a mapping profile 140 includes a set of rules for a specific domain (e.g., domain corresponding to the domain graph 152, domain corresponding to the domain graph 154). In some embodiments, a mapping profile 140 includes a set of rules for a set of use cases (e.g., a set of use cases for domain 152, a set of use cases for domain 154). In certain embodiments, the mapping profile 142 includes a mapping rule different from any mapping rules in the mapping profile 144. In some embodiment, the mapping profile 142 includes a mapping rule different from any mapping rules in the mapping profile 144 for the same source graph (e.g., source graph 110). In certain embodiments, the mapping profile 142 includes a mapping rule different from any mapping rules in the mapping profile 144 for the same domain graph (e.g., domain graph 152).

According to certain embodiments, the knowledge graph 104 includes one or more domain graphs 150. In some embodiments, a domain graph 150 (e.g., domain graph 152, domain graph 154, etc.) is for an industry, an organization, a use case, and/or the like. For example, a first domain graph 152 can be a domain graph for using sensor monitoring data to be used by electrical utilities. As an example, a second domain graph 154 can be a domain graph for using sensor monitoring data to locate an object. For example, the first domain graph 152 and the second domain graph 154 correspond to the same source graph 130 (e.g., sensor objects). As an example, a utility domain graph as a circuit breaker, a voltage sensor, and a transformer, all as different sensors, where a mapping profile (e.g., including a library) can provide the data mapping and/or data transformation from the source graph 130. For example, a utility domain graph as a circuit breaker, a voltage sensor, and a transformer, all as different sensors and each having time-series sensor values, where a mapping profile (e.g., including a library) can provide the data mapping and/or data transformation from the source graph 130. As an example, the second domain graph 154 can be a domain graph for cloud computing. In one example, the cloud computing domain graph includes CPUs (central processing units) and IoM (Internet of Manufacturing) components as sensors, where a mapping profile (e.g., including a library) can provide the data mapping and/or data transformation from the source graph 130.

In some embodiments, a domain graph, including one or more domain graph elements, is a graph database that uses nodes to store data entities and edges to store relationships between entities. In certain embodiments, the data hydration and query system 102 receives data from a source system (e.g., a vendor-specific source system) and applies the compiler to the data to hydrate a corresponding source graph (e.g., a vendor-agnostic dataset) and a domain graph (e.g., a domain-specific dataset). In some embodiments, hydrating a source graph refers to converting source data and populating the converted data to the graph database of the domain graph. In certain embodiments, hydrating a domain graph refers to converting data (e.g., via the mapping profile) and populating the converted data to the graph database of the domain graph.

According to some embodiments, the data hydration and query system 102 uses a language (e.g., YAML language, a data serialization language, etc.) encoding the knowledge graph and allows a query to start the data hydration process to populate the domain graphs 150. In certain embodiments, the data hydration and query system 102 can be integrated into various software systems and/or software services such as, for example, a language model service (e.g., a language model service to generate outputs based on queries and/or prompts), a workflow service that can be used with existing data integration, a hydration service to hydrate the source graphs 105, a pipeline builder to change an existing pipeline for a first vendor to a second vendor, a workshop service for new ways to enrich the application, and/or the like.

According to certain embodiments, the mapping profile 142 and the mapping profile 144 are used in different fields. In some embodiments, the mapping profile 142 and the mapping profile 144 are used with the same source graph such that an update to the mapping profile 142 associated with the source graph (e.g., ERP 1) can be applied to the mapping profile 144. For example, the update includes adding, modifying, and/or deleting a constraint for a data conversion.

According to some embodiments, the data hydration and query system 102 can include a portion of the one or more domain graphs 150. In certain embodiments, the data hydration and query system 102 has a governance process, where each domain graph has an owner (e.g., a pod, a team, etc.) which synthesizes and approves the contributions coming from the field. In some embodiments, the data hydration and query system 102 includes one or more sets of rules (e.g., grammars) associated the language (e.g., YAML language, a data serialization language, etc.) of the knowledge graph 104. In certain embodiments, a grammar refers to a set of rules. For example, a grammar includes a rule for data conversion. In some embodiments, the set of rules is encoded in the language of the knowledge graph 104.

In some embodiments, the data hydration and query environment 100 includes a repository (not shown) which can include and/or store data from source systems, knowledge graphs 104, source graphs 105, mapping profiles 140, domain graphs 150, and/or the like. The repository may be implemented using any one of the configurations described below. A data repository may include random access memories, flat files, XML files, and/or one or more database management systems (DBMS) executing on one or more database servers or a data center. A database management system may be a relational (RDBMS), hierarchical (HDBMS), multidimensional (MDBMS), object oriented (ODBMS or OODBMS) or object relational (ORDBMS) database management system, and the like. The data repository may be, for example, a single relational database. In some cases, the data repository may include a plurality of databases that can exchange and aggregate data by data integration process or software application. In an exemplary embodiment, at least part of the data repository may be hosted in a cloud data center. In some cases, a data repository may be hosted on a single computer, a server, a storage device, a cloud server, or the like. In some other cases, a data repository may be hosted on a series of networked computers, servers, or devices. In some cases, a data repository may be hosted on tiers of data storage devices including local, regional, and central.

In some cases, various components in the data hydration and query environment 100 can execute software or firmware stored in non-transitory computer-readable medium to implement various processing steps. Various components and processors of the data hydration and query environment 100 can be implemented by one or more computing devices including, but not limited to, circuits, a computer, a cloud-based processing unit, a processor, a processing unit, a microprocessor, a mobile computing device, and/or a tablet computer. In some cases, various components of the data hydration and query environment 100 (e.g., the data hydration and query system 102, etc.) can be implemented on a shared computing device. Alternatively, a component of the data hydration and query environment 100 can be implemented on multiple computing devices. In some implementations, various modules and components of the geospatial data analysis and visualization environment or workflow 900 can be implemented as software, hardware, firmware, or a combination thereof. In some cases, various components of the data hydration and query environment 100 can be implemented in software or firmware executed by a computing device.

Various components of the geospatial data analysis and visualization (e.g., site prospecting) environment or workflow 900 can communicate via or be coupled to via a communication interface, for example, a wired or wireless interface. The communication interface includes, but is not limited to, any wired or wireless short-range and long-range communication interfaces. The short-range communication interfaces may be, for example, local area network (LAN), interfaces conforming known communications standard, such as Bluetooth® standard, IEEE 802 standards (e.g., IEEE 802.11), a ZigBee® or similar specification, such as those based on the IEEE 802.15.4 standard, or other public or proprietary wireless protocol. The long-range communication interfaces may be, for example, wide area network (WAN), cellular network interfaces, satellite communication interfaces, etc. The communication interface may be either within a private computer network, such as intranet, or on a public computer network, such as the internet.

FIG. 2 is an illustrative diagram for data hydration (e.g., data conversion, data transformation, etc.) and query system and workflow 200, according to certain embodiments of the present application. FIG. 2 is merely an example. One of ordinary skill in the art would recognize many variations, alternatives, and modifications. For example, some of the components may be expanded, integrated, and/or combined. Other components may be inserted into those noted above. Depending upon the embodiment, the arrangement of components may be interchanged with others replaced. Further details of these components are found throughout the present disclosure.

According to certain embodiments, the data hydration and query system and workflow 200 includes a knowledge graph 202 and a compiler 204. In some embodiments, the compiler 204 corresponds to the knowledge graph 202. In certain embodiments, the knowledge graph 202 includes one or more source graphs 210, one or more mapping profiles 220 and 230, and one or more domain graphs 240. In some embodiments, the source graphs 210 correspond to the one or more mapping profiles 220. In certain embodiments, the domain graphs 240 correspond to the one or more mapping profiles 230.

According to some embodiments, the data hydration and query system 200 includes one or more mapping profiles 220 to convert data from one or more source systems 205 to one or more source graphs 210, also referred to as hydrating the source graphs 210. As an example, the data hydration and query system 200 converts data from source system 205-1 to source graph 210-1 using the mapping profile 220-1. For example, the data hydration and query system 200 converts data from source system 205-2 to source graph 210-1 using the mapping profile 220-2. As an example, the data hydration and query system 200 converts data from source system 205-3 to source graph 210-1 using the mapping profile 220-3. For example, the data hydration and query system 200 converts data from source system 205-4 to source graph 210-2 using the mapping profile 220-4. As an example, the data hydration and query system 200 converts data from source system 205-5 to source graph 210-2 using the mapping profile 220-5. For example, the data hydration and query system 200 converts data from source system 205-6 to source graph 210-3 using the mapping profile 220-6.

According to certain embodiments, the data hydration and query system 200 includes the one or more mapping profiles 230 to convert data from one or more source graphs 210 to one or more domain graphs 240, also referred to as hydrating the domain graphs 240. As an example, the data hydration and query system 200 converts data from source graph 210-1 to domain graph 240-1 using the mapping profile 230-1. For example, the data hydration and query system 200 converts data from source graph 210-1 to domain graph 240-2 using the mapping profile 230-2. As an example, the data hydration and query system 200 converts data from source graph 210-2 to domain graph 240-1 using the mapping profile 230-3. For example, the data hydration and query system 200 converts data from source graph 210-3 to domain graph 240-2 using the mapping profile 230-4.

According to some embodiments, the mapping profiles 220 and/or the mapping profiles 230 can be updated via adding, modifying, and/or deleting a rule for data conversion. In certain embodiments, the mapping profiles 220 and/or the mapping profiles 230 only after approval, for example, authentication and/or validation. In some embodiments, the data hydration and query system 200 includes a user interface for modifying the mapping profiles 220 and/or the mapping profiles 230.

According to certain embodiments, for a new source system 205, the data hydration and query system 200 will need a new set of rules and/or a new mapping profile 220. In some embodiments, the set of rules is stored in a library. In certain embodiments, for a new domain, the data hydration and query system 200 will need a new set of rules and/or a new mapping profile 230.

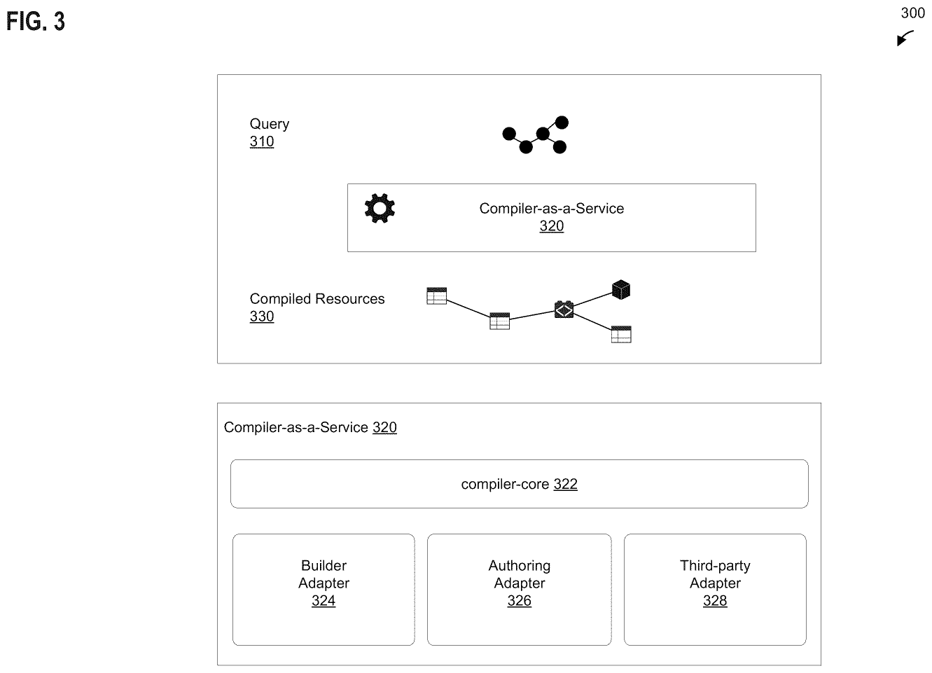

FIG. 3 is an illustrative diagram for data hydration (e.g., data conversion, data transformation, etc.) and query system and workflow 300, according to certain embodiments of the present application. FIG. 3 is merely an example. One of ordinary skill in the art would recognize many variations, alternatives, and modifications. For example, some of the components may be expanded, integrated, and/or combined. Other components may be inserted into those noted above. Depending upon the embodiment, the arrangement of components may be interchanged with others replaced. Further details of these components are found throughout the present disclosure.

According to certain embodiments, the data hydration and query system and workflow 300 includes an application registration to allow one or more users to register applications built on the language of the knowledge graph, for example, so that other users can pick and choose applications that fit their needs. In some embodiments, the data hydration and query system and workflow 300 allows users to select (e.g., via a user interface, via a software interface, etc.) one or more source graphs, domain graphs, one or more mapping profiles, and one or more software applications. In certain embodiments, the data hydration and query system and workflow 300 allows users to contribute changes to source graphs, domain graphs and/or logical mapping profiles, for example, via user inputs. In some embodiments, the data hydration and query system and workflow 300 includes a software plugin to extract relevant changes and push them to the software production environment.

According to some embodiments, the data hydration and query system and workflow 300 provides a centralized and/or stack-agnostic (e.g., computing system agnostic) location for one or more source graphs, domain graphs and/or mapping profiles, for example, outside of any single customer system's stack. In certain embodiments, the data hydration and query system and workflow 300 provides a distributed compiler to perform data hydrations. In some embodiments, the data hydration and query system and workflow 300 provides versioning to allow systems and/or users to propose and approve changes to source graphs, domain graphs and/or mapping profiles. In certain embodiments, the data hydration and query system and workflow 300 uses an expressive storage (e.g., TypeDB), for example, having a storage layer that can understand the semantic nature of entities and relationships. In some embodiments, the data hydration and query system and workflow 300 can storing mapping profiles (e.g., logics) in a data-agnostic way. In certain embodiments, a mapping profile connects one or more source graphs to a domain graph. For instance, the mapping profile does not depend on specific dataset identifiers, instead, it should allow users to parameterize the dataset identifiers. In some embodiments, the mapping profile can include one or more of authored transforms, vector notebooks, contour transforms, pipelines, and/or the like.

According to certain embodiments, the data hydration and query system and workflow 300 can receive one or more queries 310. In some embodiments, the system 300 applies a compiler 320 to the one or more queries 310 to generate compiled resources 330. In certain embodiments, the compiler 320 accepts the query 310 (e.g., a graph query) and turns the query into a data pipeline. In some embodiments, the compiler 320 includes a modular interface. In certain embodiments, the compiler 320 is a compiler-as-a-service. In some embodiments, the compiler 320 includes a compiler core 322 and one or more adapters (e.g., a building adapter 324, an authoring adapter 326, a third-party adapter 328, etc.).

According to some embodiments, the data hydration and query system and workflow 300 receives a query 310, then the compiler 320 validates the query 310, and then generate compiled resources 330. In certain embodiments, the compiler core 322 is responsible for validation. In some embodiments, an adapter (e.g., a building adapter 324, an authoring adapter 326, a third-party adapter 328, etc.) can translate into a particular storage environment (e.g., a specific language environment). In certain embodiments, the query 310 includes instructions in the language of a knowledge graph. In some embodiments, the query 310 includes instructions encoded (e.g., translated) in the language of a knowledge graph. In certain embodiments, the compiler 320 is configured to validate those instructions and then create the corresponding resources 330 that go from one or more source systems to one or more source graphs and from the one or more source graphs to one or more domain graphs.

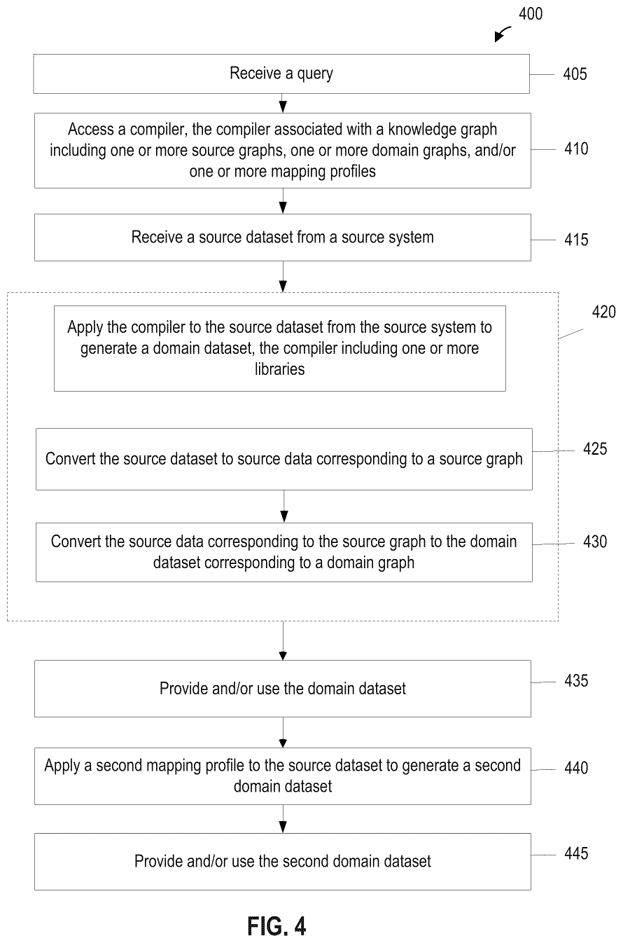

FIG. 4 is a simplified diagram showing a method 400 for data hydration and query according to certain embodiments of the present disclosure. This diagram is merely an example. One of ordinary skill in the art would recognize many variations, alternatives, and modifications. The method 400 for data hydration and query includes processes 405, 410, 415, 420, 425, 430, 435, 440, and 445. Although the above has been shown using a selected group of processes for the method 400 for data hydration and query, there can be many alternatives, modifications, and variations. For example, some of the processes may be expanded and/or combined. Other processes may be inserted into those noted above. Depending upon the embodiment, the sequence of processes may be interchanged with others replaced. Further details of these processes are found throughout the present disclosure.

In some embodiments, some or all processes (e.g., steps) of the method 400 are performed by a system (e.g., the computing system 600). In certain examples, some or all processes (e.g., steps) of the method 400 are performed by a computer and/or a processor directed by a code. For example, a computer includes a server computer and/or a client computer (e.g., a personal computer). In some examples, some or all processes (e.g., steps) of the method 400 are performed according to instructions included by a non-transitory computer-readable medium (e.g., in a computer program product, such as a computer-readable flash drive). For example, a non-transitory computer-readable medium is readable by a computer including a server computer and/or a client computer (e.g., a personal computer, and/or a server rack). As an example, instructions included by a non-transitory computer-readable medium are executed by a processor including a processor of a server computer and/or a processor of a client computer (e.g., a personal computer, and/or server rack).

According to certain embodiments, at process 405, the system receives a query. In some embodiments, the query includes one or more instructions in a language of a knowledge graph including one or more source graphs, one or more domain graphs, and/or one or more mapping profiles. In certain embodiments, at process 410, the system generates and/or accesses a compiler, where the compiler is associated with the knowledge graph including one or more source graphs, one or more domain graphs, and/or one or more mapping profiles. In some embodiments, the system receives a user query via a user input or a software interface. In certain embodiments, the system generates the query based on the user query and the knowledge graph. In some embodiments, the system generates the query using a large language model.

According to some embodiments, at process 415, the system receives a source dataset from a source system, such as a vendor specific source system. In certain embodiments, the source dataset is associated with a source data schema (e.g., a vendor specific source data schema). In some embodiments, at process 420, the system applies the compiler to the source dataset from the source system to generate a domain data corresponding to a domain graph. In certain embodiments, the process 420 includes the process 425 to convert the source dataset to source data corresponding to a source graph and/or the process 430 to convert the source data corresponding to the source graph to the domain dataset corresponding to a domain graph in the knowledge graph. In some embodiments, the process 420 includes the process 425 to convert the source dataset to source data corresponding to a source graph via one or more first mapping profiles and/or the process 430 to convert the source data corresponding to the source graph to the domain dataset corresponding to a domain graph in the knowledge graph via one or more second mapping profiles.

According to certain embodiments, at process 435, the system provides and/or uses the domain dataset. In some embodiments, at process 440, the system applies a second mapping profile to the source dataset to generate a second domain dataset corresponding to a second domain graph in the knowledge graph. In certain embodiments, in response to receiving a second query, the system applies a second mapping profile to the source dataset to generate a second domain dataset corresponding to a second domain graph in the knowledge graph. In some embodiments, at process 445, the system provides and/or uses the second domain dataset.

According to some embodiment, the compiler includes a first library corresponding to the first domain graph and a second library corresponding to a second domain graph different from the first domain graph. In certain embodiments, the first library includes a first set of rules representing a first mapping profile in the mapping profile. In some embodiments, the second library includes a second set of rules representing a second mapping profile in the mapping profile. In some embodiments, the system receives a third library corresponding to a third domain graph different from the first domain graph or the second domain graph. In certain embodiments, the system updates the compiler by incorporating the third library into the compiler.

According to certain embodiments, the first domain dataset includes a first domain data associated with a first source data type. In some embodiments, the second domain dataset is associated with the first source data type, where the first domain dataset is different from the second domain dataset in a data type or a semantic data name. In some embodiments, the source system is a first source system including a first source data schema, where the source graph is associated with a second source system including a second source data schema. In certain embodiments, the compiler includes a first library including a first set of rules for data conversion and the compiler includes a second library including a second set of rules for data conversion different from the first set of rules for conversion.

According to some embodiments, the system receives a modification to the first set of rules for conversion. In certain embodiments, the system obtains an approval, for example, via an authorizing entity, to the modification to the first set of rules for conversion. In some embodiments, the system updates the first library based at least in part on the modification to the first set of rules for conversion. In certain embodiments, the system receives an update to the first mapping profile. In some embodiments, the system modifies the second mapping profile based on the update to the first mapping profile.

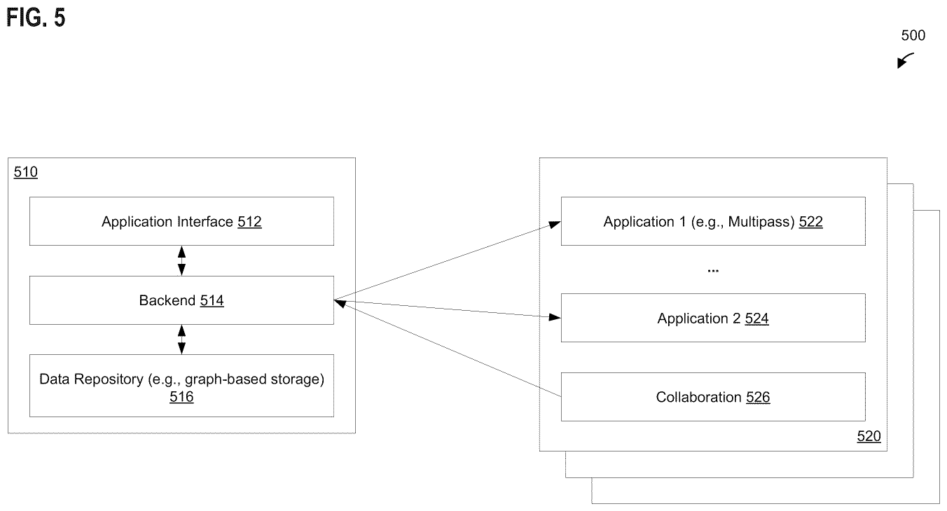

FIG. 5 is an example architecture of a data hydration and query system 500. FIG. 5 is merely an example. One of ordinary skill in the art would recognize many variations, alternatives, and modifications. In some embodiments, the data hydration and query system 500 includes a compiler 510 (e.g., a compiler service) and one or more applications 520 (e.g., application stacks). In certain embodiments, the compiler service 510 includes an application interface 512 (e.g., a user interface), one or more backend services 514, and/or one or more graph-based storages 516 (e.g., for storing source graphs and/or domain graphs). In some embodiments, the application interface 512 includes one or more entry points to exploration, deployment, and contribution to the compiler.

In certain embodiments, the one or more backend services 514 includes one or more software orchestrators for assembling and deploying artifacts to target stacks and/or one or more services to interact with target stack's microservices. In some embodiments, the one or more backend services 514 includes one or more validation services to validation contributions to mapping profiles. In some embodiments, the one or more software applications 520 includes one or more software applications (e.g., application 522, application 524, etc.) and one or more collaborations 526 (e.g., software contributions).

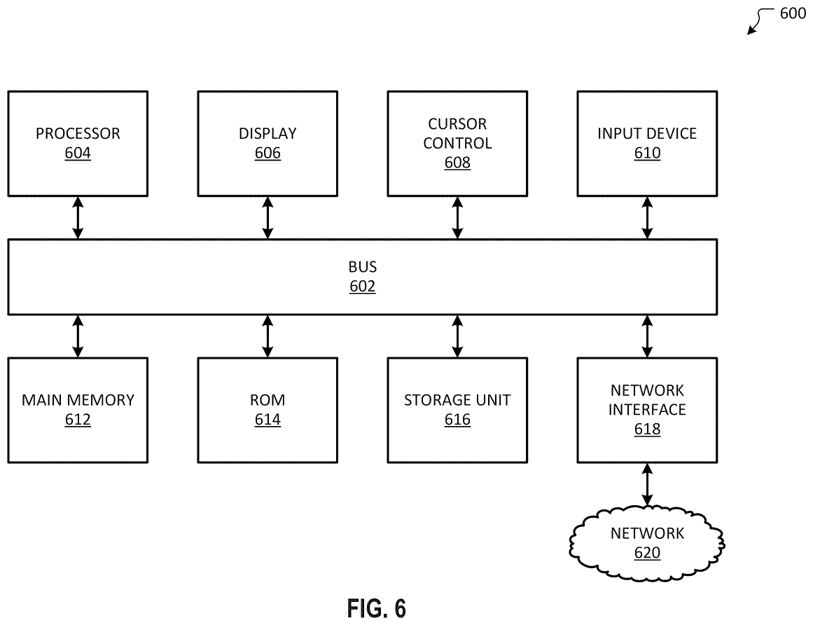

FIG. 6 is a simplified diagram showing a computing system for implementing a system 600 for data hydration and query in accordance with at least one example set forth in the disclosure. This diagram is merely an example, which should not unduly limit the scope of the claims. One of ordinary skill in the art would recognize many variations, alternatives, and modifications.

The computing system 600 includes a bus 602 or other communication mechanism for communicating information, a processor 604, a display 606, a cursor control component 608, an input device 610, a main memory 612, a read only memory (ROM) 614, a storage unit 616, and a network interface 618. In some embodiments, some or all processes (e.g., steps) of the methods 400 are performed by the computing system 600. In some examples, the bus 602 is coupled to the processor 604, the display 606, the cursor control component 608, the input device 610, the main memory 612, the read only memory (ROM) 614, the storage unit 616, and/or the network interface 618. In certain examples, the network interface is coupled to a network 620. For example, the processor 604 includes one or more general purpose microprocessors. In some examples, the main memory 612 (e.g., random access memory (RAM), cache and/or other dynamic storage devices) is configured to store information and instructions to be executed by the processor 604. In certain examples, the main memory 612 is configured to store temporary variables or other intermediate information during execution of instructions to be executed by processor 604. For examples, the instructions, when stored in the storage unit 616 accessible to processor 604, render the computing system 600 into a special-purpose machine that is customized to perform the operations specified in the instructions. In some examples, the ROM 614 is configured to store static information and instructions for the processor 604. In certain examples, the storage unit 616 (e.g., a magnetic disk, optical disk, or flash drive) is configured to store information and instructions.

In some embodiments, the display 606 (e.g., a cathode ray tube (CRT), an LCD display, or a touch screen) is configured to display information to a user of the computing system 600. In some examples, the input device 610 (e.g., alphanumeric and other keys) is configured to communicate information and commands to the processor 604. For example, the cursor control component 608 (e.g., a mouse, a trackball, or cursor direction keys) is configured to communicate additional information and commands (e.g., to control cursor movements on the display 606) to the processor 604.

According to certain embodiments, a method for data hydration is provided. The method includes: accessing a compiler, the compiler associated with a source graph, a domain graph, and a mapping profile, the domain graph including one or more domain data schemas; receiving a source dataset from a source system; and applying the compiler to the source dataset from the source system to generate a domain dataset, the domain dataset using at least one of the one or more domain data schemas; wherein the method is performed using one or more processors. For example, the method is implemented according to at least FIG. 1, FIG. 2, FIG. 3, and/or FIG. 4.

In some embodiments, the domain graph includes a first domain graph and a second domain graph, where the compiler includes a first library corresponding to the first domain graph and a second library corresponding to the second domain graph different from the first domain graph. In certain embodiments, the first library includes a first set of rules representing a first mapping profile in the mapping profile, where the second library includes a second set of rules representing a second mapping profile in the mapping profile. In some embodiments, the method further comprises: receiving a third library corresponding to a third domain graph different from the first domain graph or the second domain graph; wherein the compiler is updated by incorporating the third library into the compiler. In certain embodiments, the domain dataset is a first domain dataset and the domain graph is a first domain graph, wherein the method further comprises: applying the compiler to the source dataset to generate a second domain dataset; wherein the second domain dataset is associated with a second domain graph different from the first domain graph; wherein the second domain dataset is different from the first domain dataset.

In certain embodiments, the first domain dataset includes a first domain data associated with a first source data type, wherein the second domain dataset includes a second domain data associated with the first source data type, wherein the first domain dataset is different from the second domain dataset in a data type or a semantic data name. In some embodiments, the applying the compiler to the source dataset comprises: converting the source dataset to source data corresponding to the source graph; and converting the source data corresponding to the source graph to the domain dataset corresponding to the domain graph; wherein the source dataset is vendor-specific and the source graph is vendor agnostic; wherein the domain dataset is domain-specific. In certain embodiments, the source system is a first source system including a first source data schema, where the source graph is associated with a second source system including a second source schema.

In some embodiments, the compiler includes a first library including a first set of rules for data conversion; wherein the compiler includes a second library including a second set of rules for data conversion different from the first set of rules for conversion. In certain embodiments, the method further comprises receiving a modification to the first set of rules for conversion; obtaining an approval to the modification to the first set of rules for conversion; and updating the first library based at least in part on the modification to the first set of rules for conversion. In some embodiments, the method further comprises generating the compiler using the source graph, the domain graph and the mapping profile.

In certain embodiments, a knowledge graph includes the source graph, the domain graph and the mapping profile; where the compiler is corresponding to the knowledge graph. In some embodiments, the method further comprises receiving a query associated with the knowledge graph; and generating an output based on the query. In certain embodiments, the receiving a query associated with the knowledge graph comprises: receiving a user query via a user input or a software interface; generating the query based on the user query and the knowledge graph. In some embodiments, the generating the query comprises generating the query using a large language model. In certain embodiments, the mapping profile is a first mapping profile and the domain graph is a first domain graph, where the method further comprises: accessing a second mapping profile associated with a second domain graph and the source graph; receiving an update to the first mapping profile; and modifying the second mapping profile based on the update.

According to certain embodiments, a system for data hydration is provided. The system includes at least one processor; and memory storing instructions that, when executed by the at least one processor, cause the system to perform a set of operations. The set of operations include: accessing a compiler, the compiler associated with a source graph, a domain graph, and a mapping profile, the domain graph including one or more domain data schemas; receiving a source dataset from a source system; and applying the compiler to the source dataset from the source system to generate a domain dataset, the domain dataset using at least one of the one or more domain data schemas. For example, the system is implemented according to at least FIG. 1, FIG. 2, FIG. 3, and/or FIG. 4.

In some embodiments, the domain graph includes a first domain graph and a second domain graph, where the compiler includes a first library corresponding to the first domain graph and a second library corresponding to the second domain graph different from the first domain graph. In certain embodiments, the first library includes a first set of rules representing a first mapping profile in the mapping profile, where the second library includes a second set of rules representing a second mapping profile in the mapping profile. In some embodiments, the set of operations further includes: receiving a third library corresponding to a third domain graph different from the first domain graph or the second domain graph; wherein the compiler is updated by incorporating the third library into the compiler. In certain embodiments, the domain dataset is a first domain dataset and the domain graph is a first domain graph, wherein the set of operations further comprises: applying the compiler to the source dataset to generate a second domain dataset; wherein the second domain dataset is associated with a second domain graph different from the first domain graph; wherein the second domain dataset is different from the first domain dataset.

In certain embodiments, the first domain dataset includes a first domain data associated with a first source data type, wherein the second domain dataset includes a second domain data associated with the first source data type, wherein the first domain dataset is different from the second domain dataset in a data type or a semantic data name. In some embodiments, the applying the compiler to the source dataset comprises: converting the source dataset to source data corresponding to the source graph; and converting the source data corresponding to the source graph to the domain dataset corresponding to the domain graph; wherein the source dataset is vendor-specific and the source graph is vendor agnostic; wherein the domain dataset is domain-specific. In certain embodiments, the source system is a first source system including a first source data schema, where the source graph is associated with a second source system including a second source schema.

In some embodiments, the compiler includes a first library including a first set of rules for data conversion; wherein the compiler includes a second library including a second set of rules for data conversion different from the first set of rules for conversion. In certain embodiments, the set of operations further comprises receiving a modification to the first set of rules for conversion; obtaining an approval to the modification to the first set of rules for conversion; and updating the first library based at least in part on the modification to the first set of rules for conversion. In some embodiments, the set of operations further comprises generating the compiler using the source graph, the domain graph and the mapping profile.

In certain embodiments, a knowledge graph includes the source graph, the domain graph and the mapping profile; where the compiler is corresponding to the knowledge graph. In some embodiments, the set of operations further comprises receiving a query associated with the knowledge graph; and generating an output based on the query. In certain embodiments, the receiving a query associated with the knowledge graph comprises: receiving a user query via a user input or a software interface; generating the query based on the user query and the knowledge graph. In some embodiments, the generating the query comprises generating the query using a large language model. In certain embodiments, the mapping profile is a first mapping profile and the domain graph is a first domain graph, where the set of operations further comprises: accessing a second mapping profile associated with a second domain graph and the source graph; receiving an update to the first mapping profile; and modifying the second mapping profile based on the update.

According to certain embodiments, a method for data hydration is provided. The method includes: generating a compiler using a knowledge graph, the knowledge graph comprising a source graph, a domain graph, and a mapping profile; receiving a source dataset from a source system; and applying the compiler to the source dataset from the source system to generate a domain dataset by: converting the source dataset to source data corresponding to the source graph, wherein the source dataset is vendor-specific and the source graph is vendor agnostic; and converting the source data corresponding to the source graph to the domain dataset corresponding to the domain graph, wherein the domain dataset is domain-specific; wherein the method is performed using one or more processors. For example, the method is implemented according to at least FIG. 1, FIG. 2, FIG. 3, and/or FIG. 4.

In some embodiments, the domain graph includes a first domain graph and a second domain graph, where the compiler includes a first library corresponding to the first domain graph and a second library corresponding to the second domain graph different from the first domain graph. In certain embodiments, the first library includes a first set of rules representing a first mapping profile in the mapping profile, where the second library includes a second set of rules representing a second mapping profile in the mapping profile. In some embodiments, the method further comprises: receiving a third library corresponding to a third domain graph different from the first domain graph or the second domain graph; wherein the compiler is updated by incorporating the third library into the compiler. In certain embodiments, the domain dataset is a first domain dataset and the domain graph is a first domain graph, wherein the method further comprises: applying the compiler to the source dataset to generate a second domain dataset; wherein the second domain dataset is associated with a second domain graph different from the first domain graph; wherein the second domain dataset is different from the first domain dataset.

In certain embodiments, the first domain dataset includes a first domain data associated with a first source data type, wherein the second domain dataset includes a second domain data associated with the first source data type, wherein the first domain dataset is different from the second domain dataset in a data type or a semantic data name. In certain embodiments, the source system is a first source system including a first source data schema, where the source graph is associated with a second source system including a second source schema.

In some embodiments, the compiler includes a first library including a first set of rules for data conversion; wherein the compiler includes a second library including a second set of rules for data conversion different from the first set of rules for conversion. In certain embodiments, the method further comprises receiving a modification to the first set of rules for conversion; obtaining an approval to the modification to the first set of rules for conversion; and updating the first library based at least in part on the modification to the first set of rules for conversion. In some embodiments, the method further comprises generating the compiler using the source graph, the domain graph and the mapping profile.

In some embodiments, the method further comprises receiving a query associated with the knowledge graph; and generating an output based on the query. In certain embodiments, the receiving a query associated with the knowledge graph comprises: receiving a user query via a user input or a software interface; generating the query based on the user query and the knowledge graph. In some embodiments, the generating the query comprises generating the query using a large language model. In certain embodiments, the mapping profile is a first mapping profile and the domain graph is a first domain graph, where the method further comprises: accessing a second mapping profile associated with a second domain graph and the source graph; receiving an update to the first mapping profile; and modifying the second mapping profile based on the update.

For example, some or all components of various embodiments of the present disclosure each are, individually and/or in combination with at least another component, implemented using one or more software components, one or more hardware components, and/or one or more combinations of software and hardware components. In another example, some or all components of various embodiments of the present disclosure each are, individually and/or in combination with at least another component, implemented in one or more circuits, such as one or more analog circuits and/or one or more digital circuits. In yet another example, while the embodiments described above refer to particular features, the scope of the present disclosure also includes embodiments having different combinations of features and embodiments that do not include all of the described features. In yet another example, various embodiments and/or examples of the present disclosure can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system (e.g., one or more components of the processing system) to perform the methods and operations described herein. Other implementations may also be used, however, such as firmware or even appropriately designed hardware configured to perform the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, EEPROM, Flash memory, flat files, databases, programming data structures, programming variables, IF-THEN (or similar type) statement constructs, application programming interface, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, DVD, etc.) that contain instructions (e.g., software) for use in execution by a processor to perform the methods' operations and implement the systems described herein. The computer components, software modules, functions, data stores and data structures described herein may be connected directly or indirectly to each other in order to allow the flow of data needed for their operations. It is also noted that a module or processor includes a unit of code that performs a software operation and can be implemented, for example, as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be removed from the combination, and a combination may, for example, be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present disclosure have been described, it will be understood by those of skill in the art that there are other embodiments that are equivalent to the described embodiments. Accordingly, it is to be understood that the invention is not to be limited by the specific illustrated embodiments. Various modifications and alterations of the disclosed embodiments will be apparent to those skilled in the art. The embodiments described herein are illustrative examples. The features of one disclosed example can also be applied to all other disclosed examples unless otherwise indicated. It should also be understood that all U.S. patents, patent application publications, and other patent and non-patent documents referred to herein are incorporated by reference, to the extent they do not contradict the foregoing disclosure.

What is claimed is:

1. A method for data hydration, the method comprising:
accessing a compiler, the compiler associated with a source graph, a domain graph, and a mapping profile, the domain graph including one or more domain data schemas;
receiving a source dataset from a source system; and
applying the compiler to the source dataset from the source system to generate a domain dataset, the domain dataset using at least one of the one or more domain data schemas;
wherein the method is performed using one or more processors.

2. The method of claim 1, wherein the domain graph includes a first domain graph and a second domain graph, wherein the compiler includes a first library corresponding to the first domain graph and a second library corresponding to the second domain graph different from the first domain graph.

3. The method of claim 2, wherein the first library includes a first set of rules representing a first mapping profile in the mapping profile; wherein the second library includes a second set of rules representing a second mapping profile in the mapping profile.

4. The method of claim 2, further comprising:
receiving a third library corresponding to a third domain graph different from the first domain graph or the second domain graph;
wherein the compiler is updated by incorporating the third library into the compiler.

5. The method of claim 1, wherein the domain dataset is a first domain dataset and the domain graph is a first domain graph, wherein the method further comprises:
applying the compiler to the source dataset to generate a second domain dataset;
wherein the second domain dataset is associated with a second domain graph different from the first domain graph;
wherein the second domain dataset is different from the first domain dataset.

6. The method of claim 5, wherein the first domain dataset includes a first domain data associated with a first source data type, wherein the second domain dataset includes a second domain data associated with the first source data type, wherein the first domain dataset is different from the second domain dataset in a data type or a semantic data name.

7. The method of claim 1, wherein the applying the compiler to the source dataset comprises:
converting the source dataset to source data corresponding to the source graph; and
converting the source data corresponding to the source graph to the domain dataset corresponding to the domain graph;
wherein the source dataset is vendor-specific and the source graph is vendor agnostic;
wherein the domain dataset is domain-specific.

8. The method of claim 7, wherein the source system is a first source system including a first source data schema, wherein the source graph is associated with a second source system including a second source data schema.

9. The method of claim 1, wherein the compiler includes a first library including a first set of rules for data conversion; wherein the compiler further includes a second library including a second set of rules for data conversion different from the first set of rules for conversion.

10. The method of claim 9, further comprising:
receiving a modification to the first set of rules for conversion;
obtaining an approval to the modification to the first set of rules for conversion; and
updating the first library based at least in part on the modification to the first set of rules for conversion.

11. The method of claim 1, further comprising:
generating the compiler using the source graph, the domain graph and the mapping profile.

12. The method of claim 1, wherein a knowledge graph includes the source graph, the domain graph and the mapping profile; wherein the compiler is corresponding to the knowledge graph.

13. The method of claim 12, further comprising:
receiving a query associated with the knowledge graph; and
generating an output based on the query.

14. The method of claim 13, wherein the receiving a query associated with the knowledge graph comprises:
receiving a user query via a user input or a software interface;
generating the query based on the user query and the knowledge graph.

15. The method of claim 14, wherein the generating the query comprises generating the query using a large language model.

16. The method of claim 1, wherein the mapping profile is a first mapping profile and the domain graph is a first domain graph, wherein the method further comprises:
accessing a second mapping profile associated with a second domain graph and the source graph;
receiving an update to the first mapping profile; and
modifying the second mapping profile based on the update.

17. A system for data hydration, the system comprising:
at least one processor; and
at least one memory storing instructions that, when executed by the at least one processor, cause the system to perform a set of operations, the set of operations comprising:
accessing a compiler, the compiler associated with a source graph, a domain graph, and a mapping profile, the domain graph including one or more domain data schemas;
receiving a source dataset from a source system; and
applying the compiler to the source dataset from the source system to generate a domain dataset, the domain dataset using at least one of the one or more domain data schemas.

18. The system of claim 17, wherein the domain graph includes a first domain graph and a second domain graph, wherein the compiler includes a first library corresponding to the first domain graph and a second library corresponding to the second domain graph different from the first domain graph.

19. The system of claim 18, wherein the first library includes a first set of rules representing a first mapping profile in the mapping profile; wherein the second library includes a second set of rules representing a second mapping profile in the mapping profile.

20. A method for data hydration, the method comprising:
generating a compiler using a knowledge graph, the knowledge graph comprising a source graph, a domain graph, and a mapping profile;
receiving a source dataset from a source system; and
applying the compiler to the source dataset from the source system to generate a domain dataset by:
converting the source dataset to source data corresponding to the source graph, wherein the source dataset is vendor-specific and the source graph is vendor agnostic; and
converting the source data corresponding to the source graph to the domain dataset corresponding to the domain graph, wherein the domain dataset is domain-specific;
wherein the method is performed using one or more processors.
